(19) United States
(12) Patent Application Publication
(10) Pub. No.: US 2026/0051526 A1
(43) Pub. Date: Feb. 19, 2026

(54) PITCH CONVERSION APPARATUS FOR SECONDARY BATTERY CELLS

(71) Applicant: SK On Co., Ltd., Seoul (KR)

(72) Inventors: Kang Hyuk CHOI, Daejeon (KR); Soo Ho CHO, Daejeon (KR)

(21) Appl. No.: 19/294,282

(22) Filed: Aug. 8, 2025

(30) Foreign Application Priority Data
Aug. 19, 2024 (KR) 10-2024-0110810

(51) Int. Cl. H01M 10/04

(52) U.S. Cl. CPC H01M 10/0404

(57) ABSTRACT

Proposed is a pitch conversion apparatus for secondary battery cells including a first pick-and-place provided to load/unload a cell into/from a first tray, moved within a first section, and fixed in a pitch state of a first spacing to transfer multiple cells, a second pick-and-place provided to load/unload a cell into/from a second tray, moved within a second section, and fixed in a pitch state of a second spacing to transfer multiple cells, and a buffer part disposed at a position accessible by the first pick-and-place and the second pick-and-place, accommodating multiple cells, and provided to convert a pitch of the accommodated cells.

### CROSS REFERENCE TO RELATED APPLICATION

The present application claims priority to Korean Patent Application No. 10-2024-0110810, filed Aug. 19, 2024, the entire contents of which is incorporated herein for all purposes by this reference.

### BACKGROUND OF THE INVENTION

### Field of the Invention

The present disclosure relates to a pitch conversion apparatus for secondary battery cells.

### Description of the Related Art

In recent years, as the demand for portable electronic products such as laptops, video cameras, and mobile phones has increased rapidly and the development of electric vehicles, energy storage batteries, robots, and satellites has begun in earnest, research on high-performance secondary batteries that can be charged and discharged repeatedly is actively being conducted.

In secondary batteries, pouch-type cells are manufactured through a process of assembling cells and a process of activating cells. An outer material of a pouch-type cell generally includes a lower outer material in which an electrode assembly is accommodated, and an upper outer material that seals the upper portion of the lower outer material.

The electrode assembly is placed in a housing of the lower outer material, and the edges of the housing of the lower outer material and the corresponding edges of the upper outer material are pressed against each other, and the pressed portion is heat-welded, and then an electrolyte is poured and the remaining portion is vacuum-sealed to assemble the cell.

Meanwhile, because secondary battery cells are assembled in a discharged state, they need to be activated by first charging after assembling the cells so as to function as batteries. This is called the activation process or the formation process.

In the formation process, secondary battery cells are loaded into designated activation process equipment to ensure smooth current flow and processes such as charging and discharging are performed as conditions necessary for activation. In secondary batteries, due to the characteristics thereof, such an activation process must be carried out in advance to activate a positive electrode active material and create a stable surface layer on a negative electrode during the first cycle.

In the formation process, the layer is formed on the surface of the negative electrode through the reaction between a negative electrode active material and an electrolyte, and the physical and mechanical soundness of the surface layer determines the performance of a secondary battery until the end of the battery's life.

In addition, secondary battery cells manufactured in the cell assembly process are accommodated in multiple units on a logistics tray and then transferred to be supplied to the formation process. For the convenience of logistics, the multiple secondary battery cells accommodated on the logistics tray are arranged with a relatively dense cell spacing (pitch) compared to that of the formation process.

Since the spacing between the secondary battery cells supplied and received in the formation process is wider than the spacing between the secondary battery cells accommodated on the logistics tray, it is required to change the spacing (pitch) of the cells in the process of supplying the densely spaced secondary battery cells accommodated in the logistics tray to the formation process, and the secondary battery cells with the wider spacing between the cells may be accommodated in a separate tray with a different pitch or return material and then supplied to the formation process.

### Document of Related Art

(Patent Document 1) Korean Patent No. 10-2556804

### SUMMARY OF THE INVENTION

According to an aspect of the present disclosure, provided is a pitch conversion apparatus for secondary battery cells that can change the pitch of cells at a separate location in the middle instead of fixing the pitch during the transfer of cells from one process to another.

In addition, a pitch conversion apparatus for secondary battery cells that can increase the high-speed productivity of secondary batteries and improve cell stability during transfer.

According to another aspect of the present disclosure, provided is a pitch conversion apparatus for secondary battery cells that can be widely applied to green technology fields such as electric vehicles, battery charging stations, and solar and wind power generation using batteries.

A pitch conversion apparatus for secondary battery cells according to an embodiment of the present disclosure may include: a first pick-and-place provided to load/unload a cell into/from a first tray, moved within a first section, and fixed in a pitch state of a first spacing to transfer multiple cells; a second pick-and-place provided to load/unload a cell into/from a second tray, moved within a second section, and fixed in a pitch state of a second spacing to transfer multiple cells; and a buffer part disposed at a position accessible by the first pick-and-place and the second pick-and-place, accommodating multiple cells, and provided to convert a pitch of the accommodated cells.

In this case, a path of the first pick-and-place in the first section may be set so that the first pick-and-place moves from above the first tray toward above the buffer part, and the first pick-and-place may pick up multiple cells loaded on the first tray from above the first tray.

In addition, a path of the second pick-and-place in the second section may be set so that the second pick-and-place moves from above the second tray toward above the buffer part, and the second pick-and-place may unload multiple cells pitch-converted by the buffer part from above the second tray onto the second tray.

In addition, the buffer part may be disposed between a first stage of the first tray and a second stage of the second tray.

In addition, the buffer part may include: a base plate; a plurality of cell holders provided on the base plate, arranged horizontally apart, and provided to accommodate cells; a driving part configured to provide an external force to the cell holders so that a separation distance between the cell holders on the base plate is adjusted; and a guide rail configured to guide a movement path of the cell holders when the separation distance between the cell holders is adjusted.

In addition, each of the cell holders may include: a base part; a plurality of cell guides provided to form a symmetrical structure on the base part and spaced apart from each other so that a cell is accommodated therebetween; a seat part provided on an inner lower part of the cell guide on which the cell is seated.

In addition, the cell guides may move away from each other before the cell is inserted, and may move closer to each other after the cell is inserted to hold the cell.

In addition, the buffer part may further include a spacing adjustment link configured to connect the driving part and the cell holders, and to enable adjustment of separation distance while an external force is provided from one driving part to the plurality of cell holders.

In addition, the spacing adjustment link may include: a vertical link provided to extend downward from a bottom of each of the cell holders; and a horizontal link configured to connect adjacent vertical links in a horizontal direction, fixedly connected to one vertical link while being slidably connected to another adjacent vertical link, and provided so that adjacent cell holders maintain the first spacing or the second spacing by a sliding operation.

In addition, among the cell holders, one that is located in a center may be fixed so as not to move when the buffer part is pitch converted.

In addition, the driving part may be connected to one of the adjacent vertical links on both sides of the vertical link of the cell holder, which is fixed in the center and does not move.

The buffer part may further include a barcode reader provided near the cell holders and capable of reading a barcode on a tab part of a cell.

In addition, the barcode reader may be provided with an angle adjustment capability.

In addition, the buffer part may further include a tab centering part provided near the cell holders and used to detect a correct position of the tab part of the cell exposed to an outside of each of the cell holders.

In addition, the tab centering part may be respectively provided at each of both outer ends of the cell holder where the tab part is exposed.

The features and advantages of the present disclosure will become more apparent from the following detailed description based on the accompanying drawings.

Prior to this, terms or words used in this specification and claims should not be construed in their usual, dictionary meaning, and should be interpreted with meaning and concept consistent with the technical idea of the present disclosure on the basis of the principle that the inventor can define terminology appropriately to explain his or her invention in the best way possible.

According to an embodiment of the present disclosure, in the process of transferring cells from one process to another, by fixing the pitch during the transfer of cells and changing the pitch of cells from the first spacing to the second spacing in a separately provided buffer part, the shaking and shock of cells can be alleviated.

Furthermore, it is possible to increase the high-speed productivity of secondary batteries and increase cell stability.

Furthermore, it is possible to improve the barcode reading rate of cells by minimizing vibrations of cells and other driving systems.

### BRIEF DESCRIPTION OF THE DRAWINGS

FIG. 1 is a schematic view showing a pitch conversion apparatus for secondary battery cells according to an embodiment of the present disclosure.

FIG. 2 is a plan view showing a buffer part in a pitch state of a first spacing in a pitch conversion apparatus for secondary battery cells according to an embodiment of the present disclosure.

FIG. 3 is a cross-sectional view showing the line A-A′ of FIG. 2.

FIG. 4 is a perspective view showing the main part of a cell holder in a pitch conversion apparatus for secondary battery cells according to an embodiment of the present disclosure.

FIG. 5 is a plan view showing a buffer part in a pitch state of a second spacing in a pitch conversion apparatus for secondary battery cells according to an embodiment of the present disclosure.

FIG. 6 is a cross-sectional view showing the line B-B′ of FIG. 5.

FIG. 7 is a side view schematically showing a barcode reader provided in a pitch conversion apparatus for secondary battery cells according to an embodiment of the present disclosure.

FIG. 8 is a plan view showing the joint relationship between a vertical arm and a bracket in FIG. 7.

FIG. 9 is a side view schematically showing a tab centering part provided in a pitch conversion apparatus for secondary battery cells according to an embodiment of the present disclosure.

### DETAILED DESCRIPTION OF THE INVENTION

Terms used to describe an embodiment of the present disclosure are not intended to limit the disclosure. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments. In this document, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., are used to distinguish one component from another component, and the components are not limited by the terms.

Hereinafter, an embodiment of the present disclosure will be described in detail with reference to the attached drawings.

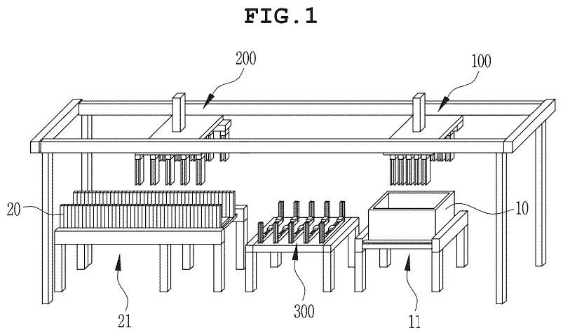

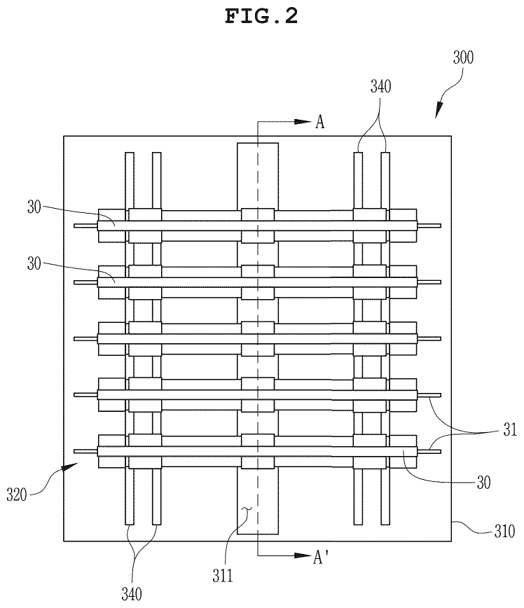

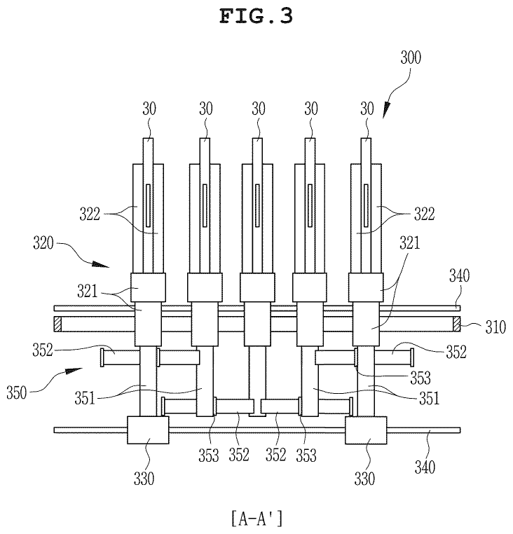

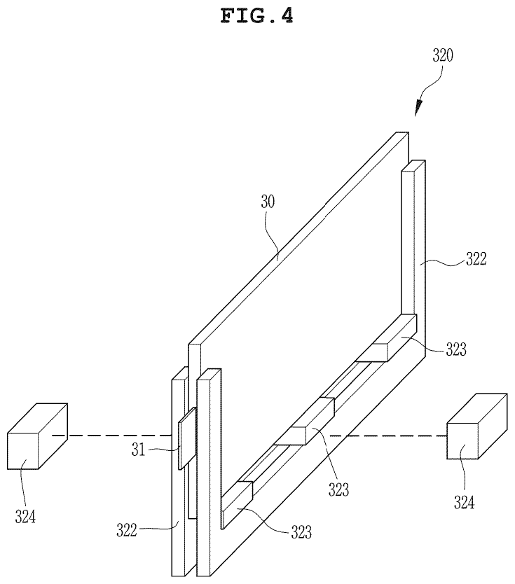

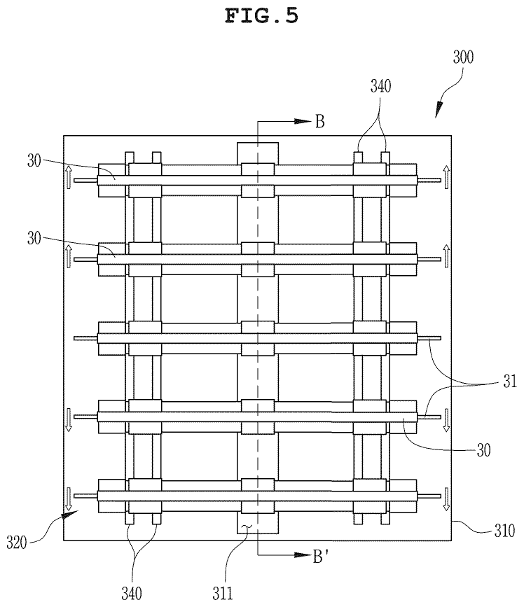

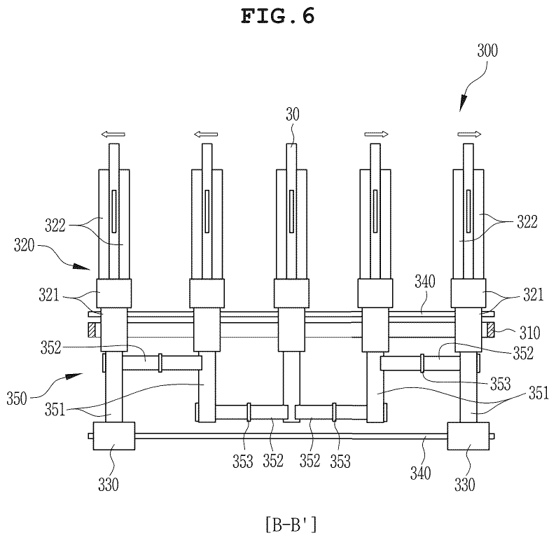

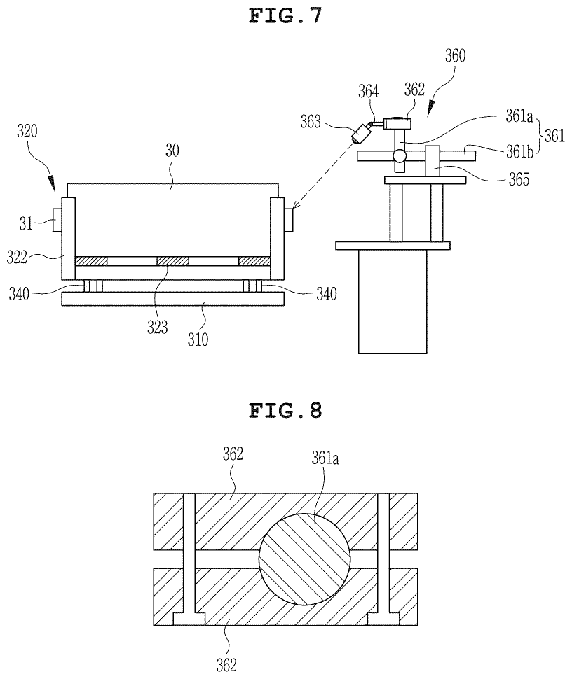

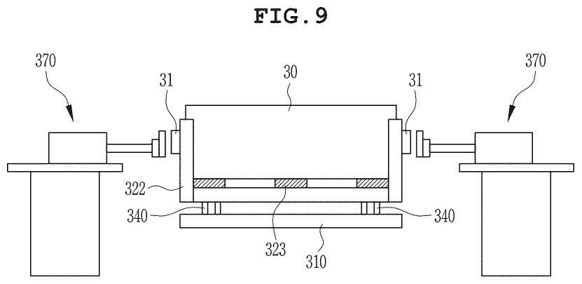

FIG. 1 is a schematic view showing a pitch conversion apparatus for secondary battery cells according to an embodiment of the present disclosure, FIG. 2 is a plan view showing a buffer part in a pitch state of a first spacing in a pitch conversion apparatus for secondary battery cells according to an embodiment of the present disclosure, FIG. 3 is a cross-sectional view showing the line A-A′ of FIG. 2, FIG. 4 is a perspective view showing the main part of a cell holder in a pitch conversion apparatus for secondary battery cells according to an embodiment of the present disclosure, FIG. 5 is a plan view showing a buffer part in a pitch state of a second spacing in a pitch conversion apparatus for secondary battery cells according to an embodiment of the present disclosure, FIG. 6 is a cross-sectional view showing the line B-B′ of FIG. 5, FIG. 7 is a side view schematically showing a barcode reader provided in a pitch conversion apparatus for secondary battery cells according to an embodiment of the present disclosure, FIG. 8 is a plan view showing the joint relationship between a vertical arm and a bracket in FIG. 7, and FIG. 9 is a side view schematically showing a tab centering part provided in a pitch conversion apparatus for secondary battery cells according to an embodiment of the present disclosure. As shown in FIG. 1, a pitch conversion apparatus for secondary battery cells according to an embodiment of the present disclosure may include: a first pick-and-place 100 provided to load/unload a cell into/from a first tray 10, moved within a first section, and fixed in a pitch state of a first spacing to transfer multiple cells; a second pick-and-place 200 provided to load/unload a cell into/from a second tray 20, moved within a second section, and fixed in a pitch state of a second spacing to transfer multiple cells; and a buffer part 300 disposed at a position accessible by the first pick-and-place 100 and the second pick-and-place 200, accommodating multiple cells, and provided to convert the pitch of the accommodated cells.

The first pick-and-place 100 is provided to pick up multiple secondary battery cells at a time and transfer the picked-up cells to another location, and may load or unload multiple cells accommodated in the first tray 10 at a time.

Thus, the first pick-and-place 100 may be provided near a first stage 11 on which the first tray 10 (e.g., process tray or logistics tray) is placed so as to load or unload cells into/from the first tray 10.

The first pick-and-place 100 moves within the first section and may load or unload cells into/from the first tray 10 and also load or unload cells into/from the buffer part 300.

In this case, the path of the first pick-and-place 100 in the first section may be set so that the first pick-and-place 100 moves from above the first tray 10 toward above the buffer part 300. In addition, the first pick-and-place 100 may pick up multiple cells loaded on the first tray 10 from above the first tray 10.

That is, the first section in which the first pick-and-place 100 moves may be determined as from above the first tray 10 to above the buffer part 300, and when the first pick-and-place 100 is positioned above the first tray 10, a pickup part of the first pick-and-place 100 may be lowered to pick up the cells accommodated in the first tray 10. Next, when the pickup part rises again after picking up the cells, the first pick-and-place 100 may move to above the buffer part 300 while holding the cells.

When the first pick-and-place 100 is positioned above the buffer part 300, the first pick-and-place 100 may lower the pickup part again to unload the cells onto the buffer part 300. Once all the cells are unloaded onto the buffer part 300, the pickup part rises again, and the first pick-and-place 100 may be moved back to above the first tray 10.

At this time, the first pick-and-place 100 may transfer multiple cells in pitch-fixed state with a pitch of the same spacing (hereinafter referred to as “first spacing”) as the pitch of the cells accommodated in the first tray 10. Accordingly, the first pick-and-place 100 may unload cells having a pitch of the first spacing onto the buffer part 300.

In the process of the first pick-and-place 100 transferring multiple cells from the first tray 10 to the buffer part 300, the cells accommodated in the first tray 10 may be transferred while maintaining the same pitch without changing the pitch. Thus, compared to the conventional case where a pitch of cells is changed during transfer, according to the present disclosure, the flow and vibration of cells may be reduced and even during high-speed transfer, the shaking of cells is reduced, preventing cell damage and ensuring stability during transfer.

The second pick-and-place 200 may be provided near a second stage 21 on which the second tray 20 is placed so as to load or unload cells into/from the second tray 20 (e.g., a separate tray with a different pitch or return material).

The second pick-and-place 200 may moves within the second section and may load or unload cells into/from the buffer part 300 and also load or unload cells into/from the second tray 20.

In this case, the path of the second pick-and-place 200 in the second section may be set so that the second pick-and-place 200 moves from above the second tray 20 toward above the buffer part 300. In addition, the second pick-and-place 200 may unload multiple cells pitch-converted by the buffer part 300 from above the second tray 20 onto the second tray 20.

That is, the second section in which the second pick-and-place 200 moves may be determined as from above the second tray 20 to above the buffer part 300, and when the second pick-and-place 200 is positioned above the buffer part 300, a pickup part of the second pick-and-place 200 may be lowered to pick up the cells accommodated in the buffer part 300. Next, when the pickup part rises again after picking up the cells, the second pick-and-place 200 may move to above the second tray 20 while holding the cells.

When the second pick-and-place 200 is positioned above the second tray 20, the second pick-and-place 200 may lower the pickup part again to unload the cells onto the second tray 20. Once all the cells are unloaded onto the second tray 20, the pickup part of the second pick-and-place 200 may rise to the original position thereof.

At this time, the second pick-and-place 200 may transfer multiple cells in pitch-fixed state with a pitch of the same spacing (hereinafter referred to as “second spacing”) as the pitch of the cells accommodated in the buffer part 300. Accordingly, the second pick-and-place 200 may unload cells having a pitch of the second spacing onto the second tray 20.

In the process of the second pick-and-place 200 transferring multiple cells from the buffer part 300 to the second tray 20, the second pick-and-place 200 transfers the cells accommodated in the buffer part 300 pitch-converted from the first spacing to the second spacing without changing the pitch of the second spacing. Thus, even during high-speed transfer, the shaking of cells is reduced, preventing cell damage and ensuring stability during transfer.

Meanwhile, the buffer part 300 may be positioned at a location accessible by both the first pick-and-place 100 and the second pick-and-place 200. The buffer part 300 is provided to accommodate multiple cells unloaded by the first pick-and-place 100.

In addition, the buffer part 300 may convert the pitch of cells having the first spacing unloaded by the first pick-and-place 100 to have the second spacing.

In this case, the buffer part 300 may be disposed between the first stage 11 of the first tray 10 and the second stage 21 of the second tray 20 (see FIG. 1).

Below, the principle of pitch conversion in the buffer part 300 and the specific configuration of the buffer part 300 are described.

As shown in FIGS. 2 and 3, the buffer part 300 may include: a base plate 310; a plurality of cell holders 320 provided on the base plate 310, arranged horizontally apart, and provided to accommodate cells 30; a driving part 330 that provides an external force to the cell holders 320 so that the separation distance between the cell holders 320 on the base plate 310 is adjusted; and a guide rail 340 that guides the movement path of the cell holders 320 when the separation distance between the cell holders 320 is adjusted. The base plate 310 is a flat plate-shaped structure on which other components of the buffer part 300 may be installed.

The cell holder 320 is provided to individually accommodate the secondary battery cells 30, and the plurality of cell holders 320 may be provided on the base plate 310 so that multiple cells 30 may be accommodated independently. In addition, the cell holders 320 may be spaced apart from each other horizontally on the base plate 310 at a predetermined interval.

To be specific, as shown in FIGS. 3 and 4, the cell holder 320 may include: a base part 321; a plurality of cell guides 322 provided to form a symmetrical structure on the base part 321 and spaced apart from each other so that the cell 30 is accommodated therebetween; and a seat part 323 provided on the inner lower part of the cell guide 322 on which the cell 30 is seated.

The base part 321 is a member that serves as the basis of the cell holder 320, and the cell guides 322 may be provided on the base part 321.

The base part 321 may be provided with a structure in which the base part 321 is fitted into the base plate 310 so that the cell holder 320 is able to move horizontally on the base plate 310 while being supported by the base plate 310.

To this end, a perforation part 311 penetrating the base plate 310 is formed on one side (e.g., the center portion) of the base plate 310, and the base part 321 may be supported by being inserted into the base plate 310 through the perforation part 311. The base part 321 may slide along the horizontal direction of the base plate 310 when an external force is applied.

The cell guide 322 may be provided in multiple pieces to form a symmetrical structure on the base part 321. The cell guides 322 may be configured to be spaced apart from each other by at least a distance corresponding to the thickness of the cell 30, and may be provided so that the cell 30 is accommodated between the cell guides 322.

When the cell is accommodated between the cell guides 322, a tab part 31 formed at least one end of the cell may be exposed or may protrude to the outside of the cell guides 322.

In addition, the cell guide 322 may guide the cell to be received in the correct position of the cell guide 322 when the cell is inserted between the cell guides 322.

In this case, the cell guides 322 may move away from each other before the cell is inserted and maintain a relatively wide gap, and then move closer to each other after the cell is inserted to hold the cell 30.

Referring to FIG. 4, the cell guides 322 are each individually connected to a mover 324 so that the cell guides 322 may be moved away from each other or closer to each other.

During the cell unloading process, when the cell is inserted into the cell holder 320, the cell guides 322 are spaced apart by the mover 324, making it easy to insert the cell, and when the cell insertion is completed, the cell guides 322 move closer to each other and the gap between the cell guides 322 becomes narrow, thereby stably holding the cell.

At this time, as the mover 324, a motor may be used to move the cell guides 322, or a hydraulic or pneumatic fluid cylinder may be used, and other power sources may also be used.

In addition, as shown in FIG. 4, the seat part 323 may be provided in multiple pieces spaced apart at an interval along the length direction of the cell guides 322 on the inner lower side of the cell guides 322. The seat part 323 may be configured in the form of a block of a soft material so that the cell inserted into the cell guides 322 is stably supported without causing damage to the cell.

In addition, referring again to FIG. 3, the driving part 330 may provide an external force to the cell holder 320 so that the separation distance between the cell holders 320 on the base plate 310 is adjusted.

The driving part 330 may be provided in a one-to-one correspondence with each cell holder 320 so as to directly provide external force to the cell holder 320, but the driving part 330 may also indirectly provide external force to the cell holder 320 through another configuration. The driving part 330 indirectly providing external force to the cell holder 320 through a different configuration will be described again later.

The guide rail 340 allows the cell holder 320 to move along a preset path on the base plate 310 when the separation distance (pitch) of the cell holder 320 is adjusted. The guide rail 340 may guide the movement path of the cell holder 320.

The guide rail 340 may be assembled with the cell holder 320 so that the cell holder 320 is able to slide. The guide rail 340 may be provided as one or as multiple pieces as needed. The number and installation location of the guide rail 340 are not particularly limited and the guide rail 340 may be appropriately provided as needed.

When a plurality of guide rails 340 are provided, the guide rails 340 may be arranged parallel to each other. In addition, the guide rail 340 may be assembled with the driving part 330 as well as the cell holder 320.

Meanwhile, referring to FIG. 3, the buffer part 300 may further include a spacing adjustment link 350 that connects the driving part 330 and the cell holders 320, and enables adjustment of separation distance while an external force is provided from one driving part 330 to the plurality of cell holders 320.

The spacing adjustment link 350 provides an external force generated from one driving part 330 to the plurality of cell holders 320, and when the external force is applied, adjusts the separation distance between the adjacent cell holders 320, thereby allowing the spacing (pitch) of the cell holders 320 to be converted to the same value.

To be specific, the spacing adjustment link 350 may include: a vertical link 351 provided to extend downward from the bottom of the cell holder 320 for each of the cell holders 320; and a horizontal link 352 that connects adjacent vertical links 351 in a horizontal direction, that is fixedly connected to one vertical link 351 while being slidably connected to another adjacent vertical link 351, and that is provided so that the adjacent cell holders 320 maintain the first spacing or the second spacing by a sliding operation.

The vertical link 351 may be provided to extend downwardly by a predetermined length on the bottom of the base part 321 that is a component of each cell holder 320. The vertical link 351 may be provided in a number corresponding to the number of cell holders 320. In this case, the downward direction in which the vertical link 351 extends may be interpreted to mean the height direction in the drawing.

For reference, FIGS. 2 and 3 show a state in which the pitch between cell holders 320 maintains the first spacing so as to accommodate cells unloaded from the first pick-and-place 100. As shown in FIGS. 2 and 3, when the cell holders 320 are provided in numbers of, for example, five, the vertical links 351 may also be provided in numbers of five.

In addition, the horizontal link 352 may be provided to connect a plurality of adjacent vertical links 351 in the horizontal direction. In this case, the horizontal direction may be interpreted as meaning a direction intersecting the vertical links 351.

The horizontal link 352 may be configured to be fixedly connected to one vertical link 351 and slidably connected to another adjacent vertical link 351.

Taking FIG. 3 as an example, assuming that the vertical link 351 on the left side of the drawing is number 1, and sequentially numbered as 2, 3, etc., as going to the right, a total of five vertical links 351 may be provided, from 1 to 5.

In the case of horizontal links 352 as well, assuming that the horizontal link 352 on the left side of the drawing is number 1, and sequentially numbered as going to the right, a total of four horizontal links 352 may be provided, from 1 to 4.

In this case, the first horizontal link 352 may be slidably connected to the first vertical link 351 and fixedly connected to the second vertical link 351. In addition, the second horizontal link 352 may be slidably connected to the second vertical link 351 and fixedly connected to the third vertical link 351.

Meanwhile, the third horizontal link 352 may be fixedly connected to the third vertical link 351 and slidably connected to the fourth vertical link 351. The fourth horizontal link 352 may be fixedly connected to the fourth vertical link 351 and slidably connected to the fifth vertical link 351.

That is, the horizontal link 352 may be fixedly connected or slidably connected to the vertical link 351 with a structure in which opposite sides of the horizontal link 352 are symmetrical with respect to the vertical link 351 located in the center. In addition, in the attached drawing, the number of cell holders 320 is shown as five by way of example, but the number of cell holders 320 is not limited thereto and may have an odd number, such as three, seven, or nine, in which case the cell holder 320 may be configured with the same mechanism as described above.

Thus, due to the movement direction of the vertical link 351 and the sliding operation between the horizontal link 352 and the vertical link 351, the plurality of cell holders 320 may maintain the first spacing between cells of the first pick-and-place 100 or may maintain the second spacing between cells of the second pick-and-place 200. By this principle, the pitch of the cells accommodated in the buffer part 300 may be converted to the first spacing or the second spacing.

At this time, the cell holder 320 located in the middle among the plurality of cell holders 320 may be fixed in position without moving when the buffer part 300 is converted in pitch.

That is, as an example of FIG. 3, the cell holder 320 located in the middle among the five cell holders 320 may be fixed in position without moving because the cell holder 320 located in the middle receives external force of the same size and opposite direction from both sides when the pitch is converted.

In this case, the driving part 330 may be connected to one of the vertical links 351 located on either side of the vertical link 351 of the cell holder 320 that is fixed in the center without moving.

For example, as shown in FIG. 3, the driving part 330 is connected to the first vertical link 351 and the fifth vertical link 351 among the plurality of vertical links 351 on each side of the vertical link 351 of the third cell holder 320 fixed in the center, so that external force may be transmitted to the first vertical link 351 and the fifth vertical link 351.

As shown in FIGS. 2 and 3, the cell holders 320 of the buffer part 300 may be set to maintain the first spacing of the same pitch so as to accommodate cells having the first spacing that are initially unloaded from the first pick-and-place 100.

Meanwhile, as shown in FIGS. 5 and 6, in the present disclosure, the driving part 330 may be moved away from the vertical link 351 of the cell holder 320 fixed in the center by a control signal of a controller not shown. Accordingly, the vertical link 351 coupled with the driving part 330 pulls the adjacent horizontal link 352 and transmits an external force to another adjacent vertical link 351, so that the plurality of cell holders 320 maintain a pitch of the second spacing different from that of the first spacing.

In this case, when the driving part 330 moves back toward the center, as shown in FIG. 6, the first vertical link 351 slides on the first horizontal link 352, and when the gap between the first cell holder 320 and the second cell holder 320 reaches the first spacing, an external force is transmitted to the second vertical link 351 by a stopper 353 present on the horizontal link 352. Accordingly, the second vertical link 351 also moves toward the vertical link 351 fixed in the center until the gap reaches the first spacing, and then stops by the stopper 353 to maintain the first spacing.

The pitch of the fifth vertical link 351 and the fourth vertical link 351 is also converted by the same mechanism, and thus a detailed description thereof is omitted.

At this time, the driving parts 330 may be assembled with a separate guide rail 340. Accordingly, the driving parts 330 may move in a direction away from the center to spread out or in a direction toward the center to gather along the guide rail 340.

The type of the guide rail 340 assembled with the driving part 330 is not particularly limited and may be applied in various ways. For example, the guide rail 340 may be provided in the form of a pipe with screw threads formed on the outer periphery thereof. In addition, the type of the driving part 330 is also not particularly limited, but when the guide rail 340 is provided in the form of a pipe with screw threads, the driving part 330 may be provided as a worm motor that wraps around the pipe from the outside and may move forward or backward along the screw threads.

As seen above, the buffer part 300 may be pitch-converted from a state in which the cell holders 320 have the first spacing as shown in FIGS. 2 and 3 to a state in which the cell holders 320 have the second spacing as shown in FIGS. 5 and 6.

Accordingly, the buffer part 300 may receive cells having the first spacing from the first pick-and-place 100, pitch-convert the cells to the second spacing, and then provide the pitch-converted cells to the second pick-and-place 200 that needs to be maintained at the second spacing.

Meanwhile, as shown in FIG. 7, the buffer part 300 may further include a barcode reader 360 provided near the cell holder 320 and capable of reading a barcode on the tab part 31 of the cell.

The barcode reader 360 may be provided to read a barcode individually provided in each cell 30 to obtain information about the corresponding cell. A barcode (not shown) may be provided on the tab part 31 formed in the cell 30, and the barcode reader 360 may be installed in a direction facing the tab part 31 having the barcode in order to read the barcode.

In this case, the barcode reader 360 may be provided with an angle adjustment capability.

Referring to FIG. 7, the barcode reader 360 is provided so as to be angle-adjusted so that the barcode reader 360 may be installed in a direction facing the tab part 31 with the barcode. To implement this, the barcode reader 360 may include a plurality of connecting arms 361 and a bracket 362.

The connecting arm 361 may include a vertical arm 361a and a horizontal arm 361b arranged in a direction intersecting each other. The angle may be adjusted by a hinge connecting the vertical arm 361a and the horizontal arm 361b.

In addition, as shown in FIG. 8, a connection arm 364 to which a reading part 363 for reading a barcode is connected may be detachably connected to the vertical arm 361a via the bracket 362. The bracket 362 may be connected to the vertical arm 361a in a form that surrounds the outer periphery of the vertical arm 361a, and may be configured to be fastened and separated by bolt connection.

When the bolt connection is loose when the bracket 362 is connected to the vertical arm 361a, the bracket 362 may rotate relative to the vertical arm 361a, so that the angle may be adjusted. In addition, the angle may be adjusted by means of a hinge between the reading part 363 and the connection arm 364.

Meanwhile, as shown in FIG. 7, the horizontal arm 361b may be slidably connected to a fixing block 365. At this time, the horizontal arm 361b is inserted into the fixing block 365 with a predetermined frictional force, so that the horizontal arm 361b is prevented from sliding arbitrarily. Only when a user applies an external force to the horizontal arm 361b to push or pull the reading part 363 toward or away from the cell holder 320, can the horizontal arm 361b be moved by overcoming the frictional force between the horizontal arm 361b and the fixing block 365. As a result, the barcode reader 360 may read the tab part 31 of the cell at an optimal position.

As shown in FIG. 9, the buffer part 300 may further include a tab centering part 370 provided near the cell holder 320 and used to detect the correct position of the tab part 31 of the cell exposed to the outside of the cell holder 320.

The tab centering part 370 is provided to determine whether the cell 30 is accurately received in the correct position of the cell holder 320, and may detect the correct position of the tab part 31 that is formed to protrude outwardly from the cell to determine whether the cell 30 is accurately received in the correct position. That is, the tab centering part 370 may relatively determine whether the cell is in the correct position by directly detecting whether the tap part 31 is in the correct position.

The tab centering part 370 detects whether the tap part 31 is in the correct position so that the second pick-and-place 200 may load cells accommodated in the cell holder 320 normally when loading the cells. Furthermore, the tab centering part 370 may improve the barcode reading rate by ensuring that the tab part 31 comes into the reading range of the barcode reader when the barcode reader 360 reads the barcode of the tab part 31.

At this time, the tab centering part 370 may be respectively provided at each of both outer ends of the cell holder 320 where the tab part is exposed.

In order to improve the ability to detect the correct position of the tab part 31, the tab centering part 370 may be respectively provided on both outer ends of the cell holder 320 to correspond to the tab part 31 formed at both ends of the cell. Accordingly, the ability to detect the correct position of the tap part 31 may be improved due to the measurement values detected from the plurality of tap centering parts 370.

Hereinafter, the operation and a pitch conversion method of the pitch conversion apparatus for secondary battery cells according to an embodiment of the present disclosure will be described.

Referring to FIG. 1, when the first tray 10 arrives at the first stage 11, the first pick-and-place 100 moves toward the first tray 10 and descends to pick up multiple cells accommodated in the first tray 10.

At this time, since the cells accommodated in the first tray 10 have a pitch of the first spacing, the first pick-and-place 100 picks up and transfers the cells to maintain the pitch of the first spacing, and the first spacing is maintained without change during transfer.

When the first pick-and-place 100 moves the cells of the first spacing and arrives at the buffer part 300, and then unloads the cells, the cells having the first spacing are placed in the cell holders 320 of the buffer part 300. When cells are inserted, the cell guides 322 of the cell holder 320 move away from each other, and when the insertion of cells is completed, the cell guides 322 move closer again to stably hold the cells. In this process, the first pick-and-place 100 rises and returns to the original position thereof.

Meanwhile, the buffer part 300 converts the pitch of the received cells from the first spacing to the second spacing. Since the principle and operation of the pitch conversion have been sufficiently explained above, they are omitted.

After the pitch of the cells accommodated in the buffer part 300 is converted to have the second spacing, the tab centering part 370 may detect whether the tab parts 31 of the cells having the second spacing accommodated in the cell holders 320 are in the correct positions. After that, the barcode may be read from the tab part 31 with the barcode by means of the barcode reader 360 to obtain cell information.

After the cell information is obtained, the second pick-and-place 200 may move toward the buffer part 300 to pick up the cells accommodated in the cell holders 320. At this time, the cells of the cell holders 320 have a pitch of the second spacing, and the second pick-and-place 200 may also be provided with a pitch of the second spacing to pick up these cells.

Before the second pick-and-place 200 picks up cells from the cell holders 320, the cell guides 322 move in the direction of spreading out again so that the cells may be easily discharged from the cell holders 320.

When the picking up of the cells from the cell holders 320 is completed, the second pick-and-place 200 moves to the second stage 21 through the rising, moving, and descending motions and unloads the cells having the second spacing onto the second tray 20.

When the unloading of the cells is completed, the second pick-and-place 200 returns to the original position thereof. The above processes may be repeated several times until the cells transferred to the second tray 20 fill the entire second tray 20. For example, if the second tray 20 may accommodate 40 cells and the number of cells that can be pitch-converted and transferred at a time is 5, the above processes may be repeated 8 times. Once the second tray 20 is fully filled with cells, the second tray 20 may be moved to another corresponding process (e.g., a formation process).

Above, the present disclosure has been described in detail through specific embodiments. The embodiments are for specifically explaining the present disclosure, and are only illustrative and do not limit the scope of the appended claims. It is obvious to those skilled in the art that various changes and modifications to the embodiments are possible within the scope and technical idea of the present disclosure, and it is natural that such changes and modifications fall within the scope of the appended claims.

What is claimed is:

1. A pitch conversion apparatus for secondary battery cells, the apparatus comprising:
a first pick-and-place provided to load/unload a cell into/from a first tray, moved within a first section, and fixed in a pitch state of a first spacing to transfer multiple cells;
a second pick-and-place provided to load/unload a cell into/from a second tray, moved within a second section, and fixed in a pitch state of a second spacing to transfer multiple cells; and
a buffer part disposed at a position accessible by the first pick-and-place and the second pick-and-place, accommodating multiple cells, and provided to convert a pitch of the accommodated cells.

2. The apparatus of claim 1, wherein a path of the first pick-and-place in the first section is set so that the first pick-and-place moves from above the first tray toward above the buffer part, and the first pick-and-place picks up multiple cells loaded on the first tray from above the first tray.

3. The apparatus of claim 2, wherein a path of the second pick-and-place in the second section is set so that the second pick-and-place moves from above the second tray toward above the buffer part, and the second pick-and-place unloads multiple cells pitch-converted by the buffer part from above the second tray onto the second tray.

4. The apparatus of claim 1, wherein the buffer part is disposed between a first stage of the first tray and a second stage of the second tray.

5. The apparatus of claim 1, wherein the buffer part comprises:
a base plate;
a plurality of cell holders provided on the base plate, arranged horizontally apart, and provided to accommodate cells;
a driving part configured to provide an external force to the cell holders so that a separation distance between the cell holders on the base plate is adjusted; and
a guide rail configured to guide a movement path of the cell holders when the separation distance between the cell holders is adjusted.

6. The apparatus of claim 5, wherein each of the cell holders comprises:
a base part;
a plurality of cell guides provided to form a symmetrical structure on the base part and spaced apart from each other so that a cell is accommodated therebetween;
a seat part provided on an inner lower part of the cell guide on which the cell is seated.

7. The apparatus of claim 6, wherein the cell guides move away from each other before the cell is inserted, and move closer to each other after the cell is inserted to hold the cell.

8. The apparatus of claim 5, wherein the buffer part further comprises:
a spacing adjustment link configured to connect the driving part and the cell holders, and to enable adjustment of separation distance while an external force is provided from one driving part to the plurality of cell holders.

9. The apparatus of claim 8, wherein the spacing adjustment link comprises:
a vertical link provided to extend downward from a bottom of each of the cell holders; and
a horizontal link configured to connect adjacent vertical links in a horizontal direction, fixedly connected to one vertical link while being slidably connected to another adjacent vertical link, and provided so that adjacent cell holders maintain the first spacing or the second spacing by a sliding operation.

10. The apparatus of claim 9, wherein among the cell holders, one that is located in a center is fixed so as not to move when the buffer part is pitch converted.

11. The apparatus of claim 10, wherein the driving part is connected to one of the adjacent vertical links on both sides of the vertical link of the cell holder, which is fixed in the center and does not move.

12. The apparatus of claim 5, wherein the buffer part further comprises:
a barcode reader provided near the cell holders and capable of reading a barcode on a tab part of a cell.

13. The apparatus of claim 12, wherein the barcode reader is provided with an angle adjustment capability.

14. The apparatus of claim 12, wherein the buffer part further comprises:
a tab centering part provided near the cell holders and used to detect a correct position of the tab part of the cell exposed to an outside of each of the cell holders.

15. The apparatus of claim 14, wherein the tab centering part is respectively provided at each of both outer ends of the cell holder where the tab part is exposed.
